(19) United States
(12) Patent Application Publication
(10) Pub. No.: US 2010/0035199 A1
(43) Pub. Date: Feb. 11, 2010

(54) MOUTH-WORN ORNAMENTAL JEWELRY FOR MOUNTING ON BRACES

(76) Inventor: Hendrina Catharina Antonia Koole-Nieuwenhuis, Hoofddorp (NL)

Correspondence Address: BRINKS HOFER GILSON & LIONE, P.O. BOX 10395, CHICAGO, IL, 60610, US

(21) Appl. No.: 12/304,983

(22) PCT Filed: Jun. 5, 2007
(86) PCT No.: PCT/NL2007/050262

§ 371 Date: Jun. 29, 2009

(30) Foreign Application Priority Data
Jun. 15, 2006 (NL) NL-1032009

(51) Int. Cl. A61C 7/14; A61C 7/02

(52) U.S. Cl. 433/3; 433/8

(57) ABSTRACT

There is disclosed an assembly comprising: a brace for correcting the position of teeth and/or molars, and an ornamental element. The assembly comprises an ornamental element which is provided with means for engagement with the brace. The engaging means are provided with one or more toothings configured to be detachably clamped to the brace, in particular to the part of the brace that is present between adjacent teeth.

The present invention relates to an assembly comprising: a brace for correcting the position of teeth and/or molars, and an ornamental element.

The present invention further relates to an ornamental element suitable for use in said assembly, and to a method for fitting said ornamental element.

Such an assembly is known from DE-102 40 721. The assembly that is known therefrom comprises a brace and an ornamental element, which ornamental element forms part of the jaw orthopaedic support of the brace that is attached to the teeth. The ornamental elements placed on the teeth, partially behind the support, may have a desired pattern or shape, such as a daisy, a heart or a locomotive.

A drawback of the known assembly is the fact that the support partially hides the ornamental element from view, and another drawback is the fact that the selection of an ornamental element that is made upon placement of the bracket on the tooth by the orthodontist is a definitive one for the period that the brace is to be worn.

The object of the present invention is to provide an ornamental element which can be composed by the wearer himself or herself at a moment to be chosen by said wearer.

In order to accomplish that object, the assembly according to the invention is characterised in that the assembly comprises an ornamental element which is provided with means for engagement with the brace.

An advantage of the assembly according to the invention is that the engaging means on the ornamental element enable the wearer to fit the ornament himself or herself at a desired moment after the brace has been placed.

Another advantage is the fact that the placement of the brace by an orthodontist, which is usually a costly affair, is not interfered with or rendered even costlier because one or more ornamental elements must be fitted as well. Moreover, the fitting or the presence of one or more ornamental elements does not interfere with the technical function of the brace while the brace is worn.

Preferably, the engaging means present on the ornamental elements are configured as means that can be detached from the brace.

The advantage of this is that it has become possible to adapt the brace to the user's current wishes by a flexible exchange of one or more ornamental elements.

Another embodiment of the assembly according to the invention is characterised in that the engaging means comprise clamping elements, which make it readily possible to fit or remove ornamental elements either manually or by means of a pair of pliers.

Another embodiment of the assembly according to the invention is characterised in that the brace comprises elongated elements, such as wires or bars, and that the engaging means are configured to be brought into detachable or non-detachable engagement with said elements.

Because of this manner of attachment, the provision of ornamental elements on all the usual braces has become possible in a way that suits all purses.

A strong assembly that will not easily come loose is further characterised in that the engaging means are provided with one or more toothings configured to be detachably clamped to the brace.

A preferred embodiment of the invention is according to the invention characterised in that the engaging means have dimensions that make it possible to engage elongated elements of the brace that are present between adjacent teeth.

The engaging means engage the elongated elements of the brace between adjacent teeth in an alternative manner in that case. If desired, the gap-like space between teeth, which has a considerable with in some cases, can be easily hidden from view in that case.

The assembly according to the present invention will now be explained in more detail with reference to the figures below, in which like numerals indicate like parts. In the figures:

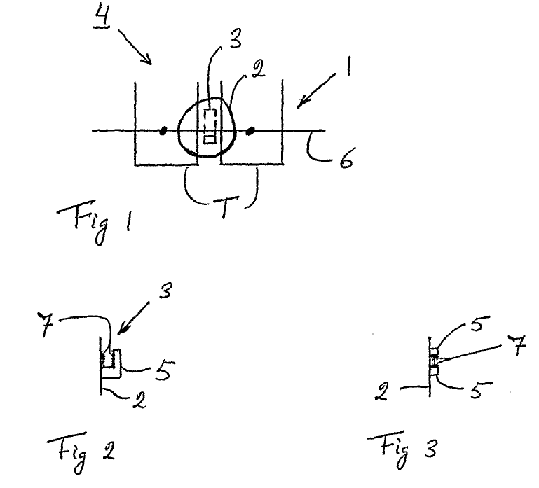

FIG. 1 shows an embodiment of the assembly according to the invention;

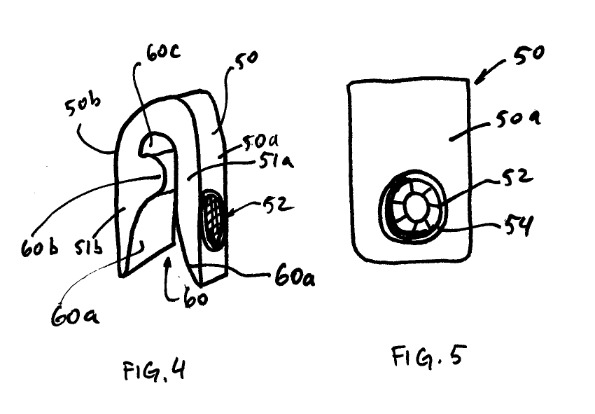

FIG. 2 shows a detail of a first embodiment of the ornamental element according to the invention; and

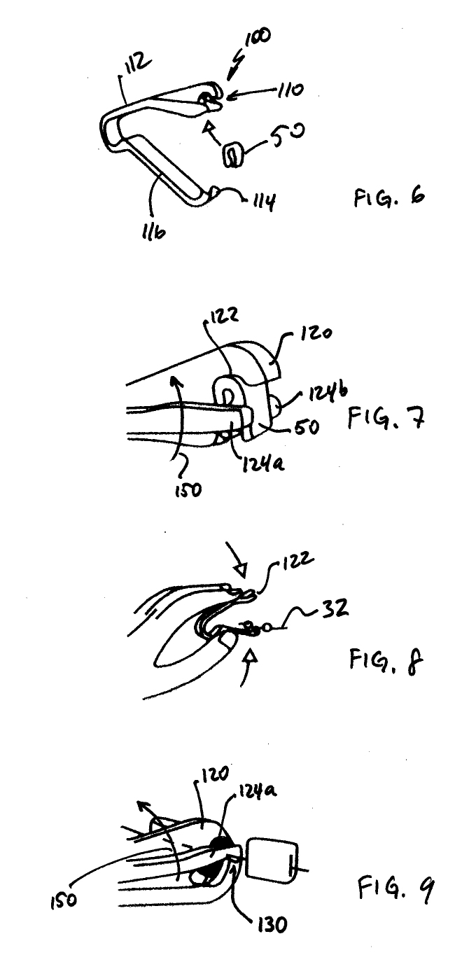

FIG. 3 shows a detail of a second embodiment of the ornamental element according to the invention.

FIG. 1 shows a brace 1 that is used for correcting the position of teeth T and/or molars. Together with an ornamental element 2 that is provided with engaging means 3, with which the ornamental element on the brace 1 can be brought into engagement, the brace 1 forms part of an assembly 4. The engaging means 3 are configured as means that can be detached from the brace 1.

In an embodiment that is shown in detail view in FIG. 2, the engaging means 3 comprise clamping elements 5, which can be brought into engagement with elongated elements, such as wires 6 or bars of the brace 1, and which can preferably be detached therefrom. The clamping elements 5 for example comprise one or more internal toothings 7, which can be detachably clamped to the wires of the brace 1 and which slightly move apart whilst clampingly engaging the wire 6. This can be readily done at home by the wearer, either manually or simply by using pliers. The engaging means 3 have width, height and depth dimensions which enable the engaging means to engage parts of the wires 6 of the brace 1 that are present between the illustrated adjacent teeth T.

Apart from a possible decoration, such as a stone, which may or may not be coloured, the ornamental element 2 itself is made of a metal or of a plastic material, which are preferably of a medical quality and/or purity. An ornamental element, albeit with adapted dimensions, might be attached to a pair of spectacles (not shown), in which case suitably configured and designed engaging means will be clamped to the arms of the spectacles.

It is preferred in practise to manufacture the clamping elements 5 from a plastic or synthetic material, which is flexible, though strong enough and not breakable. The different parts of the elements 5 can also be made from different types of plastic, such that its bending paw parts extending between the teeth T are slightly more flexible than the more solid parts of the elements 5, where an actual bending force is applied on the plastic in particular where the ornamental element 2 joins the paw. Such an embodiment of a multi-type plastic clamping element 5 combines the advantages of sufficient flexibility to allow easy removal of the brace 1 and sufficient strength to allow the brace to absorb the applied bending forces at the bending place without flexing or breaking.

1. An assembly comprising:
a brace for correcting the position of teeth, and
an ornamental element having engaging means for engaging the element to the brace.

2. The assembly according to claim 1, wherein the engaging means is configured to be detachable from the brace.

3. The assembly of claim 1 wherein the engaging means comprises clamping elements.

4. The assembly of claim 1, wherein the brace comprises elongated elements, and the engaging means is configured to be brought into detachable or non-detachable engagement with said elongated elements.

5. The assembly of claim 1, wherein the engaging means further comprises at least one toothing configured to be detachably clamped to the brace.

6. The assembly of claim 1, wherein the engaging means is sized to engage elongated elements of the brace that extend present between adjacent teeth.

7. The assembly of claim 1 wherein the engaging means further comprises a straddling member for engagement with the brace.

8. The assembly of claim 7, wherein the ornamental element is configured for mounting to at least a portion of a pair of spectacles.

9. The assembly of claim 8, wherein the engaging means further comprises clamping means configured to engage the arms of a pair of spectacles.

10. The assembly of claim 1 wherein the ornamental element further comprises a metal or plastic material having a medical quality and purity.

11. (canceled)

12. An system for installing an ornamental element to a brace wire, said system comprising:
an ornamental element having a pair of straddling members defining a gap, and an ornamental object secured thereto;
an installation tool having a pair of main arms movable towards each other, a pushing finger centered between a pair of elongated and flexible retaining arms on one of said main arms, and a pushing claw on said opposing main arm, said pushing finger including a recess for holding said ornamental element oriented for placement over said brace wire with said flexible retaining arms laterally stablilizing said ornamental element within said recess, and said pushing claw being engageable with said brace wire to cooperate with said pushing finger to snap said ornamental element over said brace wire, said brace wire extending through said gap of said element.

13. An ornamental element for mounting to a brace wire, said ornamental element comprising:
a pair of integrally molded straddling members, said members defining a gap therebetween and at least a bulbous projection from an inner wall of the gap and a retention area within the gap and adjacent said bulbous projection; and
an ornamental object embedded in at least one of said straddling members.
